(19) United States
(12) Patent Application Publication
(10) Pub. No.: US 2023/0327216 A1
(43) Pub. Date: Oct. 12, 2023

(54) LITHIUM-ION COIN BATTERY HAVING A WINDING CORE AS AN ANODE LEAD AND A CATHODE LEAD AND METHOD OF MANUFACTURING THE SAME

(71) Applicant: CYNTEC CO., LTD., Hsinchu (TW)

(72) Inventors: Pei-I Wei, Hsinchu (TW); Chih-Hsuan Chang, Hsinchu (TW)

(73) Assignee: CYNTEC CO., LTD., Hsinchu (TW)

(21) Appl. No.: 18/094,403

(22) Filed: Jan. 9, 2023

Related U.S. Application Data
(60) Provisional application No. 63/329,487, filed on Apr. 11, 2022.

(51) Int. Cl. H01M 10/0587; H01M 10/0525; H01M 50/109; H01M 50/153; H01M 10/0585

(52) U.S. Cl. CPC H01M 10/0587; H01M 10/0525; H01M 50/109; H01M 50/153; H01M 10/0585

(57) ABSTRACT

A lithium-ion coin battery having a winding core as an anode lead and a cathode lead is provided in the present invention, including a winding core having a first electrode section, a second electrode section and an insulating section isolating the first electrode section and the second electrode section, an electrode winding having a first electrode sheet, a second electrode sheet and a separator isolating between the first electrode sheet and the second electrode sheet, wherein the electrode winding winds on the winding core, and the first electrode sheet is electrically coupled with the first electrode section of the winding core, the second electrode sheet is electrically coupled with the second electrode section of the winding core, and the separator is coupled with the insulating section of the winding core.

### CROSS REFERENCE TO RELATED APPLICATIONS

This application claims the benefit of U.S. Provisional Application No. 63/329,487, filed on Apr. 11, 2022. The content of the application is incorporated herein by reference.

### BACKGROUND OF THE INVENTION

### 1. Field of the Invention

The present invention relates generally to a lithium-ion coin battery, and more specifically, to a lithium-ion coin battery having a winding core as an anode lead and a cathode lead.

### 2. Description of the Related Art

With the trend of increasing miniaturization for electrical appliances and electronic products (such as Bluetooth headsets, hearing aids, and electronic watches), the market's demands for small-sized lithium-ion batteries with high energy density are increasing. Miniaturized rechargeable coin batteries (or referred as button cells) can meet market demands owing to their characteristics of wide usage temperature, reusability, long storage time, stable discharge voltage, etc. In addition, with the development of 5G technology and the popularization of wearable devices and Internet of Things (IOT) applications, it is foreseeable that miniaturized rechargeable coin battery will have broader prospects in the future. Accordingly, there is a need for those of skilled in the art to improve the structure of rechargeable coin battery in order to set electrode winding with larger volume and increase energy density of the battery.

### SUMMARY OF THE INVENTION

The present invention hereby provides a lithium-ion coin battery, featuring the design of using the winding core as an anode lead and a cathode lead to couple to electrode shells, thereby providing more space and convenience for battery assembly and miniaturization. In addition, the metal casing is provided with an edge-locking rim at the same side of the metal cover for clamping the metal cover and at the same time functioning as an anode or a cathode, to achieve same-side electrodes design for the application of mobile devices or compact devices.

One aspect of the present invention is to provide a lithium-ion coin battery having a winding core as an anode lead and a cathode lead, including: a winding core having a first electrode section, a second electrode section and an insulating section isolating the first electrode section and the second electrode section; an electrode winding having a first electrode sheet, a second electrode sheet and a separator isolating between the first electrode sheet and the second electrode sheet, wherein the electrode winding winds on the winding core and the first electrode sheet is electrically coupled with the first electrode section of the winding core, and the second electrode sheet is electrically coupled with the second electrode section of the winding core, and the separator may be or may not be coupled with the insulating section of the winding core; a metal casing, wherein the winding core and the electrode winding are set in the metal casing, and the second electrode section of the winding core is electrically coupled with the metal casing; and a metal cover, wherein the metal cover and the metal casing collectively enclose the winding core and the electrode winding, and the first electrode section of the winding core is electrically coupled with the metal cover.

Another aspect of the present invention is to provide a method of manufacturing a lithium-ion coin battery having a winding core as an anode lead and a cathode lead, including steps of: providing a winding core, wherein the winding core comprises a first electrode section, a second electrode section and an insulating section isolating the first electrode section and the second electrode section; welding a first electrode sheet, a second electrode sheet and a separator respectively on the first electrode section, the second electrode section and the insulating section, wherein the separator is isolated between the first electrode sheet and the second electrode sheet, and the a first electrode sheet, the second electrode sheet and the separator constitutes an electrode winding; winding the electrode winding around the winding core; placing the electrode winding and the winding core in a metal casing; sealing a metal cover on the metal casing so that the metal cover and the metal casing are enclosed the electrode winding and the winding core; and welding the first electrode section and the second electrode section respectively with the metal cover and the metal casing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the embodiments, and are incorporated in and constitute apart of this specification. The drawings illustrate some of the embodiments and, together with the description, serve to explain their principles. In the drawings:

FIG. 1 is a schematic isometric view and cross-sectional view of a lithium-ion coin battery in accordance with one embodiment of the present invention;

FIG. 2 is an exploded view of a lithium-ion coin battery in accordance with one embodiment of the present invention;

FIG. 3 is a schematic isometric view of a winding core in accordance with one embodiment of the present invention;

FIG. 4 is a schematic isometric view of a winding core coupled with electrode sheets and separators in accordance with one embodiment of the present invention;

FIG. 5 is a schematic isometric view of a winding core in accordance with another embodiment of the present invention;

FIG. 6 is a schematic isometric view of a winding core coupled with electrode sheets and separators in accordance with another embodiment of the present invention;

FIG. 7 is a schematic isometric view of a winding core coupled with electrode sheets and separators in accordance with still another embodiment of the present invention;

FIG. 8 is a schematic top view of a winding core coupled with electrode sheets and separators in accordance with still another embodiment of the present invention;

FIG. 9 is a schematic lateral view of a winding core coupled with electrode sheets and separators in accordance with still another embodiment of the present invention;

FIG. 10 is a schematic isometric view of a winding core coupled with electrode sheets and separators in accordance with still another embodiment of the present invention;

FIG. 11 is a schematic top view of a winding core coupled with electrode sheets and separators in accordance with still another embodiment of the present invention;

FIG. 12 is a schematic lateral view of a winding core coupled with electrode sheets and separators in accordance with still another embodiment of the present invention; and

FIG. 13 to FIG. 16 are schematic isometric views illustrating a process flow of manufacturing a lithium-ion coin battery having a winding core as an anode lead and a cathode lead in accordance with one embodiment of the present invention.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following detailed description of the present invention, reference is made to the accompanying drawings which form a part hereof and is shown by way of illustration and specific embodiments in which the invention may be practiced. These embodiments are described in sufficient details to enable those skilled in the art to practice the invention. Other embodiments may be utilized and structural, logical, and electrical changes may be made without departing from the scope of the present invention. The following detailed description, therefore, is not to be taken in a limiting sense, and the scope of the present invention is defined by the appended claims.

It should be readily understood that the meaning of “on,” “above,” and “over” in the present disclosure should be interpreted in the broadest manner such that “on” not only means “directly on” something but also includes the meaning of “on” something with an intermediate feature or a layer therebetween, and that “above” or “over” not only means the meaning of “above” or “over” something but can also include the meaning it is “above” or “over” something with no intermediate feature or layer therebetween (i.e., directly on something). Further, spatially relative terms, such as “beneath,” “below,” “lower,” “above,” “upper,” and the like, may be used herein for ease of description to describe one element or feature's relationship to another element(s) or feature(s) as illustrated in the figures.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. Additionally, the term “based on” may be understood as not necessarily intended to convey an exclusive set of factors, but may allow for the presence of other factors not necessarily expressly described, again depending at least in part on the context.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

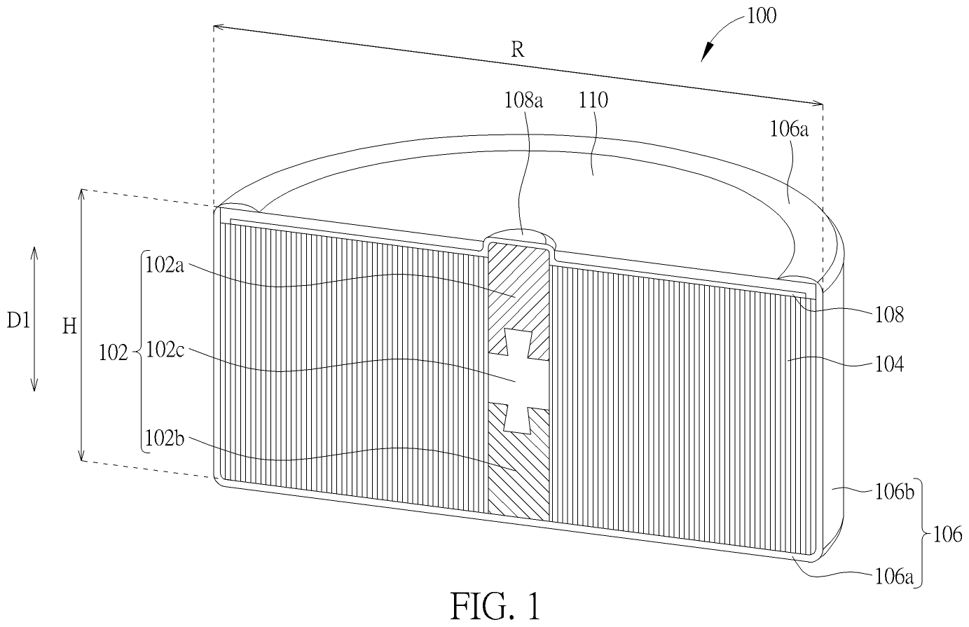

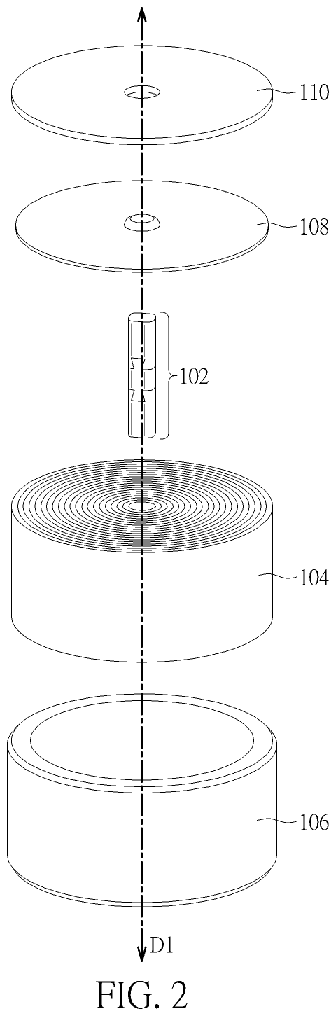

First, please referring concurrently to FIG. 1 and FIG. 2, which are schematic isometric view (with cross-section) and exploded view of a lithium-ion coin battery in accordance with one embodiment of the present invention. The lithium-ion coin battery 100 of present invention generally includes components of a winding core 102, an electrode winding 104, a metal casing 106, a metal cover 108 and an insulating cover 110. These components are assembled along an axial direction D1 through steps of, for example, winding the electrode winding 104 around the winding core 102, mounting the electrode winding 104 and the winding core 102 in a space defined by the metal casing 106, and covering the metal cover 108 and the insulating cover 110 sequentially on the electrode winding 104 and the winding core 102, and clamping an edge-locking rim 106a extending from the metal casing 106 on the insulating cover 110 so that the metal cover 108 and the insulating cover 110 are fixed on the electrode winding 104 and the electrode winding 104 and the winding core 102 are enclosed and sealed by the metal cover 108 and the metal casing 106.

Referring still to FIG. 1 and FIG. 2. The metal casing 106 of the present invention may include a bottom 106a and a sidewall 106b, for example, in a cylindrical shape with low aspect ratio (H/R). After assembly, the metal cover 108 is positioned opposite to the bottom 106a and welded directly with a first electrode section 102a of the winding core 102. The bottom 106a of metal casing 106 is welded directly with a second electrode section 102b of the winding core 102. The electrode winding 104 is mounted in the space defined by the metal casing 106 so that the sidewall 106b of the metal casing 106 surrounds the electrode winding 104 along its circumferential direction. The welding method used in the present invention may be a laser welding process.

In one embodiment of the present invention, a slightly, upwardly protruding portion 108a of the metal cover 108 is exposed from a hole of the insulating cover 110, and may function as a cathode of the lithium-ion coin battery. The protruding portion 108a is electrically coupled with the first electrode section 102a of the winding core 102 in the metal casing 106 through welding. The edge-locking rim 106c of the metal casing 106 may function as an anode of the lithium-ion coin battery. In other embodiment, the protruding portion 108a of the metal cover 108 may also function as an anode of the lithium-ion coin battery, and the edge-locking rim 106c of the metal casing 106 may also function as a cathode of the lithium-ion coin battery. The edge-locking rim 106c is electrically coupled with the second electrode section 102b of the winding core 102 in the metal casing 106 through welding between the bottom 106a of metal casing 106 and the second electrode section 102b of the winding core 102. The metal cover 108 and the metal casing 106 (including the edge-locking rim 106c) are electrically insulated by the insulating cover 110. In this way, a same-side electrodes design may be achieved for applications in compact mobile devices. In the present invention, the edge-locking rim 106c may be an extending portion bended inwardly from the sidewall 106b of metal casing 106. The material of metal casing 106 and metal cover 108 may be nickel or alloy thereof, aluminum or alloy thereof, copper-plated steel, or stainless steel with good structural strength and electrical conductivity to protect the assembly and function as an electrode. The material of insulating cover 110 may be non-conductive, vapor-proof pad with moderate resilience for sealing the inner components.

In the present invention, please note that since the present invention doesn't use structure like conductors in the related art that usually protrudes from the electrode winding 104 in the axial direction D1 to couple to the electrode winding 104 and the electrodes (i.e. exposed cover portion 108a and edge-locking rim 106c), much space may be saved in the axial direction D1 to reduce the total height H of the coin battery and achieve a more compact and low-profile battery design. In addition, since the present invention uses a metal plate cover rather than conventional metal cup to cover and enclose the electrode winding 104. The thickness of sidewall of the battery housing may be reduced to further shrink the size of coin battery.

Please referring to FIG. 3, which is a schematic isometric view of the winding core 102 in accordance with one embodiment of the present invention. The winding core 102 of present invention is, for example, a rod-shaped structure with high aspect ratio (L/R) and extending in the axial direction D1. The winding core 102 is consisted of three parts, i.e. the first electrode section 102a, the second electrode section 102b and the insulating section 102c. The insulating section 102c is electrically isolated between the first electrode section 102a and the second electrode section 102b, and the three parts may be jointed together through a tenon structure as shown in the figure along the axial direction D1. The material of first electrode section 102a and second electrode section 102b may be conductive metal like aluminum, nickel or copper, and the material of insulating section 102c may be a non-conductive material like plastic for electrically insulating the first electrode section 102a and the second electrode section 102b.

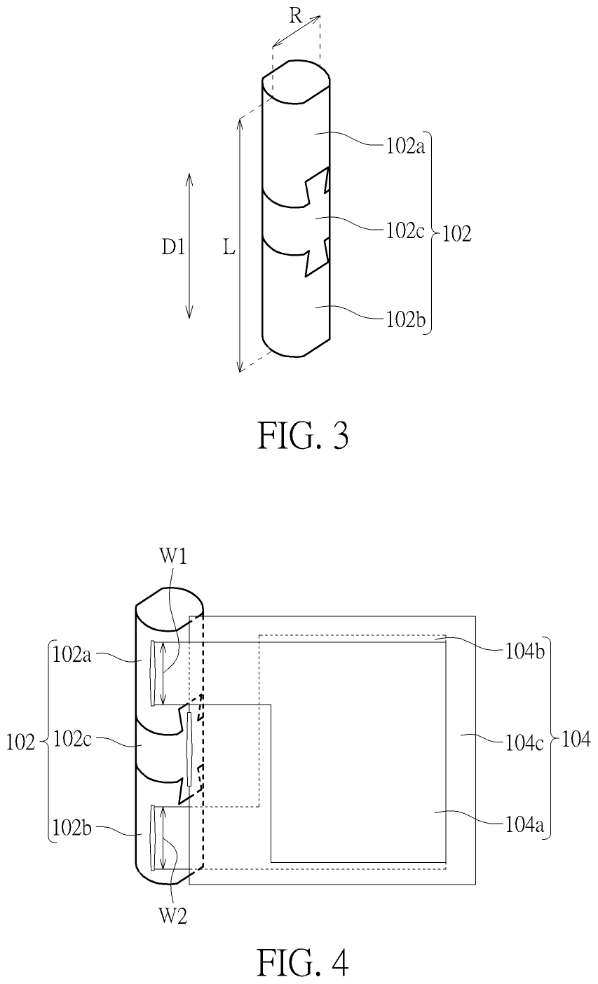

Please referring to FIG. 4, which is a schematic isometric view of the winding core 102 coupled with electrode sheets and separators in accordance with one embodiment of the present invention. Different from the conductors widely used in the related art, the winding core 102 is used in the present invention to function as an anode lead and a cathode lead configured to electrically couple to electrode sheets with the outer electrodes. As shown in FIG. 4, a first electrode sheet 104a, a second electrode sheet 104b and a separator 104c are provided to constitute the electrode winding 104 of the present invention, wherein the first electrode sheet 104a is electrically coupled with the sidewall of first electrode section 102a of the winding core 102 through welding. The second electrode sheet 104b is electrically coupled with a sidewall of second electrode section 102b of the winding core 102 through welding. The separator 104c is isolated between the first electrode section 102a and the second electrode section 102b and may be or may not be coupled with the insulating section 102c of the winding core 102 through plastic melting and fusion. A width W1 of a portion of the first electrode sheet 104a welded on the first electrode section 102a in the axial direction D1 is, for example, smaller than a length of the first electrode section 102a in the axial direction D1. A width W2 of a portion of the second electrode sheet 104b welded on the second electrode section 102b in the axial direction D1 is, for example, smaller than a length of the second electrode section 102b in the axial direction D1. A width of the separator 104c in the axial direction D1 is, for example, larger than the width of first electrode sheet 104a or the width of second electrode section 102b in order to provide better electrical insulation.

In the embodiment, the first electrode sheet 104a, the second electrode sheet 104b and the separator 104c may be a winding assembly in a form of flat layers. The first electrode sheet 104a and the second electrode sheet 104b are, for example, laminated or adhesively bonded onto the separator 104c. The electrode sheet 104a, 104b and the separator 104c generally each have thicknesses only in a μm (micrometer) range. The whole bonded and laminated sheets will be wounded around the winding core 102 to form the electrode winding 104 of the present invention after they are welded on the winding core 102. The material of first electrode sheet 104a may be lithium insertion compounds like LiCoO₂, LiNiO₂, LiMn₂O₄, LiNiₓCo_{y}Mn_{z}O₂, or LiFePO₄. The material of second electrode sheet 104b may be Li, graphite, Si, SiOx, Li₄Ti₅O₁₂, etc. These electrochemically active materials may be coated on prepared sheets before layer bonding and winding processes. A porous plastic film made at least one of polyethylene (PE) or Polypropylene (PP), which may be or may be not with ceramic powder or aluminum oxide, may be used as the separator 104c in the present invention, which is thermoplastically deformable in the electrode winding 104. The electrolyte used in the battery may include organic solvent like propylene carbonate, ethylene carbonate, dimethyl carbonate, diethyl carbonate, ethyl methyl carbonate, propiolic acid or butyrolactone and lithium compound solute like LiPF₆, LiBF₄, LiClO₄, LiAsF₆, LiCF₃SO₃ and/or LiBr, LiFSI, LiTFSI.

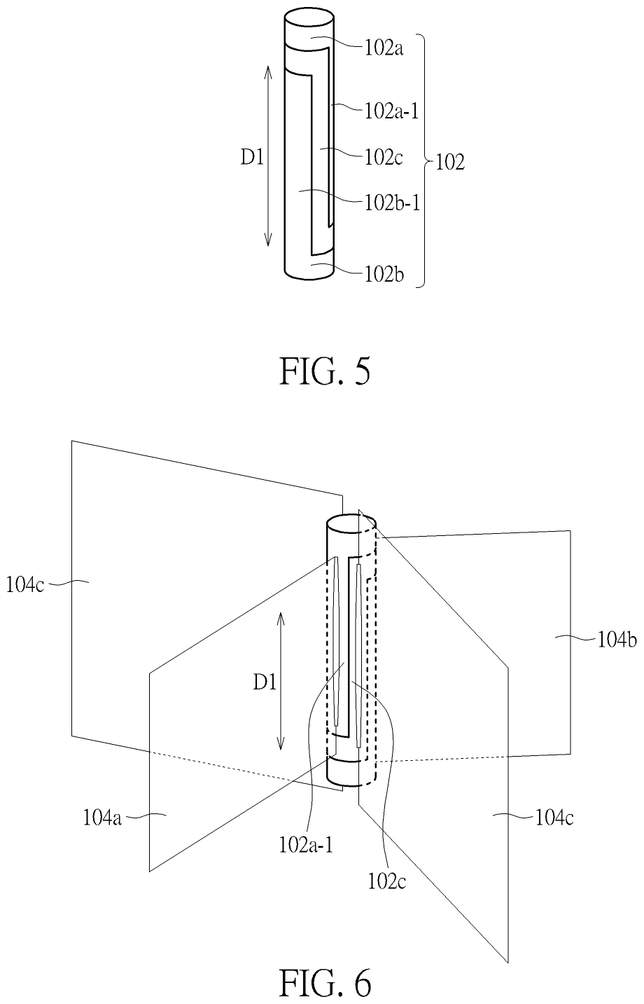

Please referring to FIG. 5, which is a schematic isometric view of the winding core 102 in accordance with another embodiment of the present invention. The winding core 102 in this embodiment is similar to the one in previous embodiment, with the difference that the first electrode section 102a, the second electrode section 102b and the insulating section 102c are not jointed through a tenon structure. Instead, in this embodiment, the first electrode section 102a and the second electrode section 102b are provided respectively with a first extending portion 102a-1 and a second extending portion 102b-1 extending in the axial direction D1 to the middle of the rod-shaped structure. The insulating section 102c also extends in the axial direction D1 between the first extending portion 102a-1 and second extending portion 102b-1 and bonds the two portions 102a-1, 102b-1 together to form the rod-shaped structure.

Please referring to FIG. 6, which is a schematic isometric view of the winding core 102 of FIG. 5 coupled with electrode sheets and separators in accordance with another embodiment of the present invention. The advantage of the winding core design of FIG. 5 is that it can provide larger welding region for electrode sheets. As shown in FIG. 6, for example, the first extending portion 102a-1 extending in the axial direction D1 provide a larger welding region than the one in the embodiment of FIG. 4 for the first electrode sheet 104a to be welded thereon. The insulating section 102c extending in the axial direction D1 may also provide a larger melting region than the one in the embodiment of FIG. 4 for the separator 104c to be fused thereon.

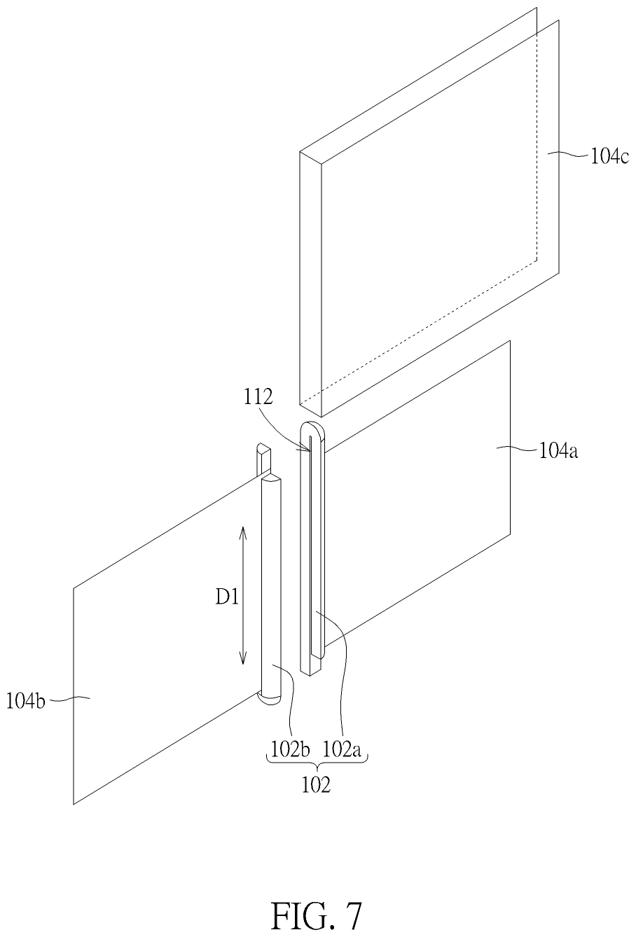

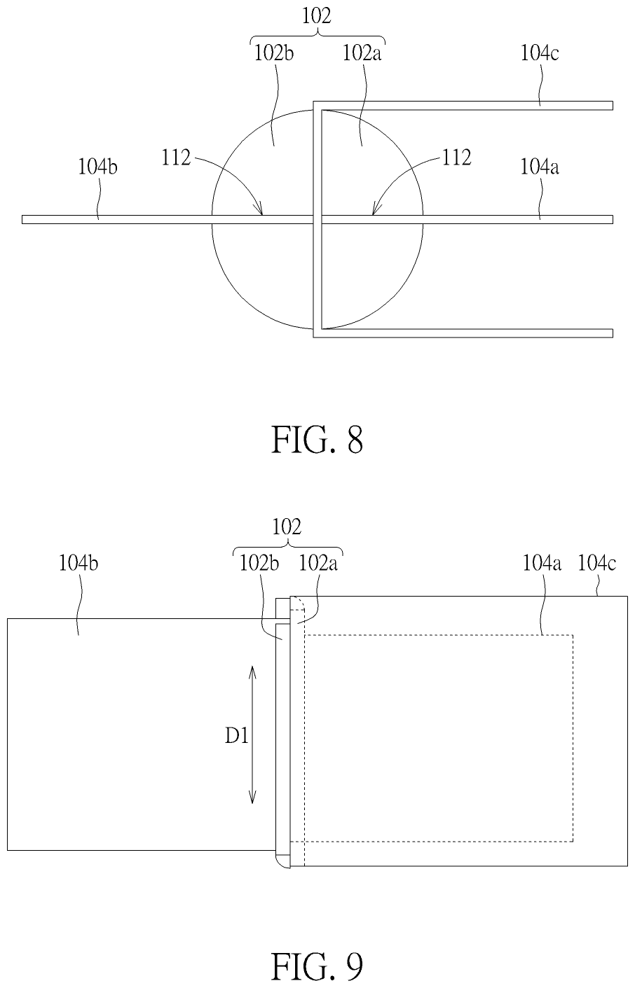

Please referring simultaneously to FIG. 7, FIG. 8 and FIG. 9, which are schematic isometric view, top view and lateral view of a winding core coupled with electrode sheets and separators respectively in accordance with still another embodiment of the present invention. In this embodiment, different from previous embodiments, the first electrode sheet 104a, the second electrode sheet 104b and the separator 104c are fixed on the winding core 102 through a clamping method rather than the welding method. As shown in the figures, the separator 104c is, for example, clamped and fixed by the first electrode section 102a and the second electrode section 102b of the winding core 102 at two sides, so that the separator 104c electrically isolates between the first electrode section 102a and the second electrode section 102b. That is, the separator 104c in this embodiment also functions as the insulating section 102c of the winding core 102 in previous embodiments. The first electrode section 102a and the second electrode section 102b may combine to form a winding core 102 in a rod shape with high aspect ratio. For example, the first electrode section 102a and the second electrode section 102b may be two halves of the winding core 102 that are cut lengthwise in an axial direction D1 of the winding core 102.

In addition, in this embodiment, the first electrode sheet 104a and the second electrode sheet 104b are clamped in the slits 112 formed respectively by the first electrode section 102a and the second electrode section 102b. The width of slit 112 may be larger than the thickness of first electrode sheet 104a or second electrode sheet 104b, so that they can be clamped and fixed thereon. The separator 104c exposed from the winding core 102 may isolate between the first electrode section 102a and the second electrode section 102b. The advantage of this embodiment is that the electrode sheets can be clamped and electrically coupled with the winding core without additional welding processes, so that spot welding unit is not necessary in winding tools and production capacity may be improved.

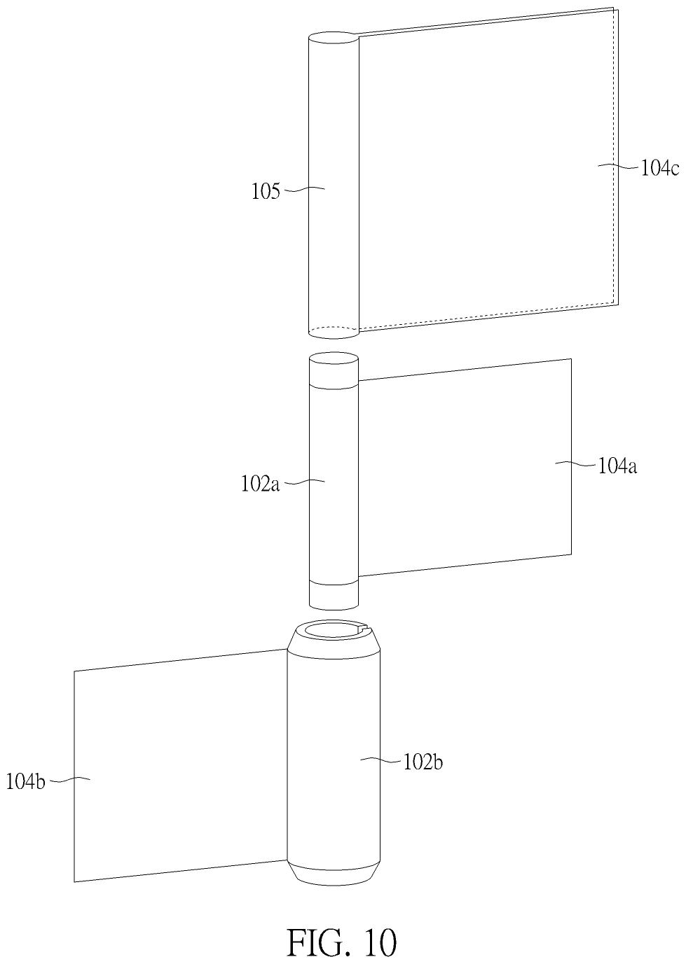

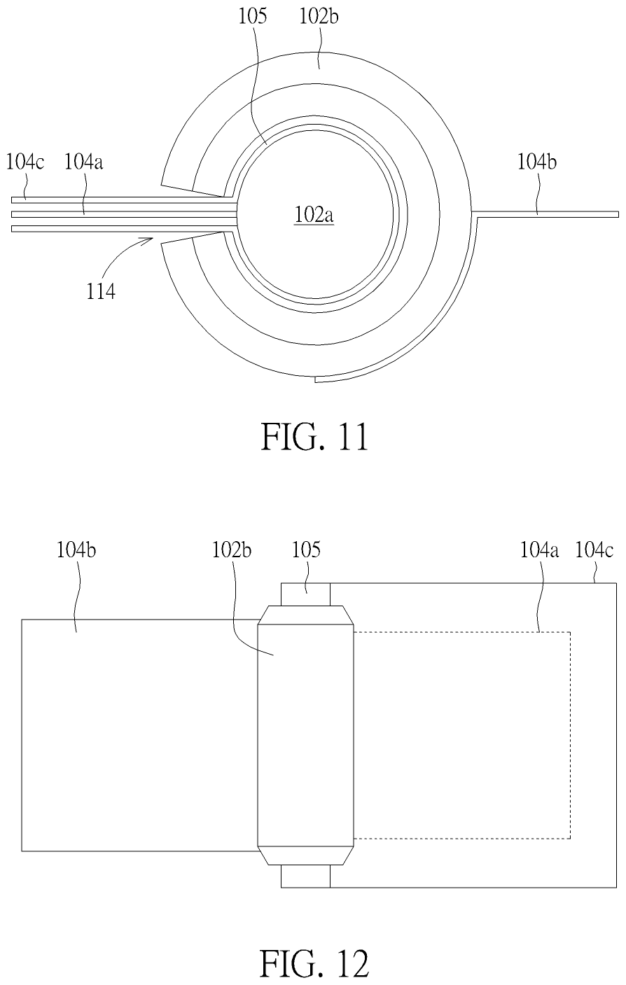

Please referring simultaneously to FIG. 10, FIG. 11 and FIG. 12, which are schematic isometric view, top view and lateral view of a winding core coupled with electrode sheets and separators respectively in accordance with still another embodiment of the present invention. In this embodiment, different from previous embodiments, the first electrode section 102a, the second electrode section 102b and the separator 104c are assembled by sleeve coupling. As shown in the figures, the first electrode section 102a and the second electrode section 102b of the winding core may be in a form of cylindrical sleeves that couples to the first electrode sheet 104a or the second electrode sheet 104b, and the separator 104c may include a cylindrical sleeve section 105 that coupling to its sheet section. The three sleeves are configured to have different diameters. For example, the diameter of second electrode section 102b is larger than the diameter of sleeve section 105 of the separator 104c and further larger than the diameter of second electrode section 102a, so that they may be assembled and be adapted to fit over each other in a pivotable, slidable way.

After the assembly, as shown in the figures, the innermost first electrode section 102a is enveloped by the sleeve section 105 of the separator 104c and further enveloped by the outermost second electrode section 102b. The intermediate sleeve section 105 of the separator 104c electrically isolates the first electrode section 102a and the second electrode section 102b. That is, the separator 104c itself in this embodiment functions as the insulating section 102c in previous embodiments. An opening 114 is provided in the outermost second electrode section 102b for the inner separator 104c and first electrode sheet 104a extending outwardly therefrom, and the second electrode sheet 104b is attached or welded on an outer surface of the second electrode section 102b. The separator 104c extending outside the second electrode section 102b may electrically isolate the first electrode sheet 104a and the second electrode sheet 104b. The advantage of this embodiment is that the winding core may be made by simple metal processing rather than complicated injection molding, so that production cost may be reduced.

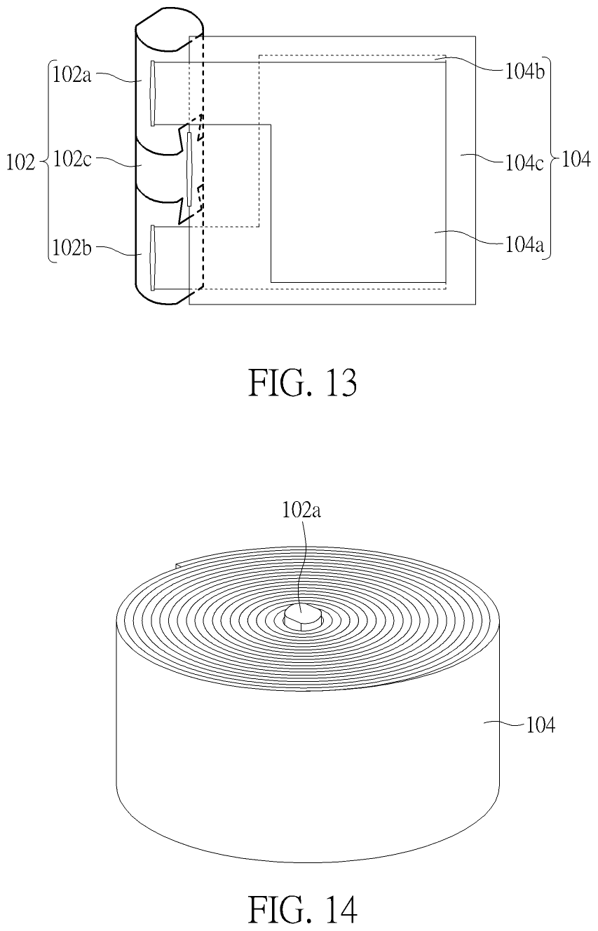

Please referring sequentially to FIG. 13 to FIG. 16, which are schematic isometric views illustrating a method of manufacturing a lithium-ion coin battery having a winding core as an anode lead and a cathode lead in accordance with one embodiment of the present invention.

First, as shown in FIG. 13, providing a winding core 102, wherein the winding core 102 includes a first electrode section 102a, a second electrode section 102b and an insulating section 102c isolating the first electrode section 102a and the second electrode section 102b. The three parts may be jointed together through a tenon structure as shown in the figure along the axial direction to form a rod-shaped structure with high aspect ratio and extending in the axial direction. The material of first electrode section 102a and second electrode section 102b may be conductive metal like aluminum, nickel or copper, and the material of insulating section 102c may be non-conductive material like plastic for electrically insulating the first electrode section 102a and the second electrode section 102b.

Referring still to FIG. 13. After the first electrode section 102a, the second electrode section 102b and an insulating section 102c are assembled, a first electrode sheet 104a, a second electrode sheet 104b and a separator 104c are welded respectively on the first electrode section 102a, the second electrode section 102b and the insulating section 102c. The separator 104c is isolated between the first electrode sheet 104a and the second electrode sheet 104b. The first electrode sheet 104a, the second electrode sheet 104b and the separator 104c constitute collectively an electrode winding 104. The first electrode sheet 104a may be electrically coupled with the sidewall of first electrode section 102a through laser welding. The second electrode sheet 104b may be electrically coupled with a sidewall of the second electrode section 102b through laser welding. The separator 104c may be or may not be coupled with the insulating section 102c through plastic melting and fusion.

Please referring to FIG. 14. After the first electrode section 102a, the second electrode section 102b and an insulating section 102c are welded on the winding core 102, the whole electrode winding 104 composed of the first electrode section 102a, the second electrode section 102b and an insulating section 102c are winded around the winding core 102 along the circumferential direction as shown in the figure. The electrode winding 104 may be in a cylindrical shape with low aspect ratio, and the first electrode section 102a and the second electrode section (not shown) are exposed respectively from the top surface and bottom surface of the electrode winding 104.

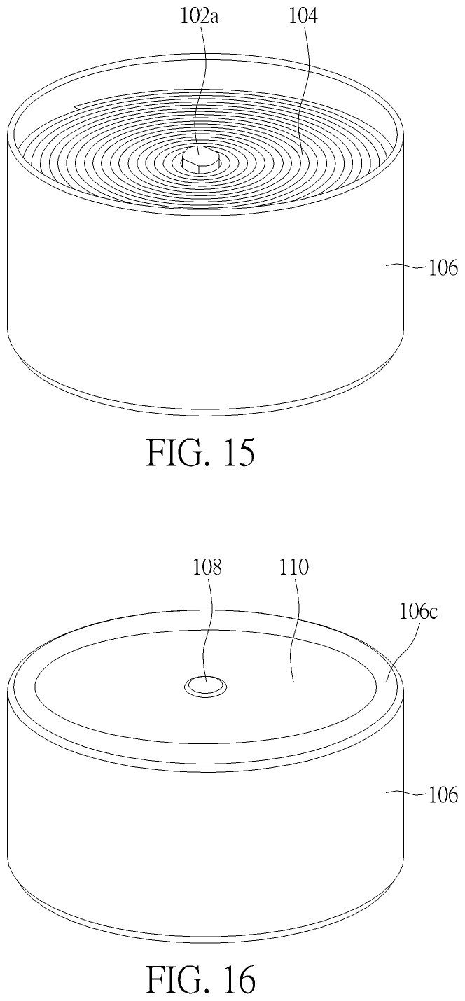

Please referring to FIG. 15. After the electrode winding 104 are winded, the electrode winding 104 is placed together with the winding core 102 in a metal casing 106. The metal casing 106 defines a space corresponding to the shape of the winded electrode winding 104. The electrode winding 104 may be tightly mounted in the space with its second electrode section (not shown) welded directly with the bottom of metal casing 106, and the sidewall of the metal casing 106 surrounds the electrode winding 104. For example, the length of metal casing 106 in the axial direction may be larger than the ones of electrode winding 104 and winding core 102, so that excess portion of the metal casing 106 may be bended to form an edge-locking rim for sealing the electrode winding 104 in the metal casing 106 in later process.

Please referring to FIG. 16. After the electrode winding 104 is placed in the metal casing 106, a metal cover 108 and an insulating cover 110 are placed sequentially on the electrode winding 104 and winding core 102 in the metal casing 106, and the excess portion of metal casing 106 are then bended to form an edge-locking rim 106c extending inwardly from the metal casing 106 on the insulating cover 110, so that the metal cover 108 and the insulating cover 110 are clamped and fixed on the electrode winding 104, and the electrode winding 104 and the winding core 102 are enclosed and sealed by the metal cover 108 and the metal casing 106. In the embodiment of present invention, the metal cover 108 is exposed from a central hole of the insulating cover 110, and may function as a cathode of the lithium-ion coin battery. A welding process may be performed on this exposed portion of metal cover 108 to electrically couple the metal cover 108 and the first electrode section 102a of the winding core 102 inside the metal casing. The edge-locking rim 106c of metal casing 106 electrically coupled with the second electrode section 102b of winding core 102 may function as an anode of the lithium-ion coin battery. Since the metal cover 108 exposed from the insulating cover 110 and electrically coupled with the first electrode section 102a of winding core 102 may function as a cathode of the lithium-ion coin battery, the metal cover 108 and the metal casing 106 (including the edge-locking rim 106c) are electrically insulated by the insulating cover 110. In other embodiment, the metal cover 108 may also function as an anode of the lithium-ion coin battery, and the metal casing 106 may also function as a cathode of the lithium-ion coin battery.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lithium-ion coin battery having a winding core as an anode lead and a cathode lead, comprising:
a winding core comprising a first electrode section, a second electrode section and an insulating section isolating the first electrode section and the second electrode section;
an electrode winding comprising a first electrode sheet, a second electrode sheet and a separator isolating between the first electrode sheet and the second electrode sheet, wherein the electrode winding winds on the winding core, and the first electrode sheet is electrically coupled with the first electrode section of the winding core, the second electrode sheet is electrically coupled with the second electrode section of the winding core;
a metal casing, wherein the winding core and the electrode winding are set in the metal casing, and the second electrode section of the winding core is electrically coupled with the metal casing; and
a metal cover, wherein the metal cover and the metal casing collectively enclose the winding core and the electrode winding, and the first electrode section of the winding core is electrically coupled with the metal cover.

2. The lithium-ion coin battery having the winding core as the anode lead and the cathode lead of claim 1, wherein the metal casing comprises a bottom and a sidewall, the bottom is opposite to the metal cover and coupled directly with the second electrode section of the winding core, and the sidewall surrounds the electrode winding, and the metal cover is coupled directly with the first electrode section.

3. The lithium-ion coin battery having the winding core as the anode lead and the cathode lead of claim 2, further comprising an insulating cover on an outer side of the metal cover and a portion of the metal cover exposed from the insulating cover, and the metal casing further comprises an edge-locking rim extending inwardly from the sidewall, wherein the edge-locking rim is clamped the insulating cover on the metal cover.

4. The lithium-ion coin battery having the winding core as the anode lead and the cathode lead of claim 1, wherein the winding core is a rod-shaped structure extending in an axial direction of the lithium-ion coin battery, and the first electrode section and the second electrode section are respectively two ends of the rod-shaped structure with the insulating section in a middle portion of the rod-shaped structure.

5. The lithium-ion coin battery having the winding core as the anode lead and the cathode lead of claim 4, wherein the first electrode section and the second electrode section are jointed together through a tenon structure.

6. The lithium-ion coin battery having the winding core as the anode lead and the cathode lead of claim 4, wherein the first electrode sheet is welded on the first electrode section at a sidewall of the rod-shaped structure, the second electrode sheet is welded on the second electrode section at the sidewall of the rod-shaped structure, and the separator is welded on the insulating section at the sidewall of the rod-shaped structure.

7. The lithium-ion coin battery having the winding core as the anode lead and the cathode lead of claim 6, wherein a width of a portion of the first electrode sheet welded on the first electrode section in the axial direction is smaller than a length of the first electrode section in the axial direction, and a width of a portion of the second electrode sheet welded on the second electrode section in the axial direction is smaller than a length of the second electrode section in the axial direction.

8. The lithium-ion coin battery having the winding core as the anode lead and the cathode lead of claim 4, wherein the first electrode section comprises a first extending portion extending in the axial direction to the middle portion of the rod-shaped structure, and the second electrode section comprises a second extending portion extending in the axial direction to the middle portion of the rod-shaped structure, and the insulating section extends in the axial direction and is positioned between the first extending portion of the first electrode section and the second extending portion of the second electrode section.

9. The lithium-ion coin battery having the winding core as the anode lead and the cathode lead of claim 1, wherein the winding core is a rod-shaped structure extending in an axial direction of the lithium-ion coin battery, and the first electrode section and the second electrode section are respectively two halves of the rod-shaped structure cut lengthwise in the axial direction.

10. The lithium-ion coin battery having the winding core as the anode lead and the cathode lead of claim 9, wherein the insulating section is a part of the separator, and the insulating section is clamped and fixed by the first electrode section and the second electrode section at two sides.

11. The lithium-ion coin battery having the winding core as the anode lead and the cathode lead of claim 9, wherein the first electrode sheet is clamped and fixed on the first electrode section, and the second electrode sheet is clamped and fixed on the second electrode section.

12. The lithium-ion coin battery having the winding core as the anode lead and the cathode lead of claim 1, wherein the winding core is a rod-shaped structure extending in an axial direction of the lithium-ion coin battery, and the first electrode section and the second electrode section are in a form of sleeve, and the separator comprises a sleeve section, and the first electrode section is enveloped by the sleeve section and further enveloped by the second electrode section through sleeve coupling.

13. The lithium-ion coin battery having the winding core as the anode lead and the cathode lead of claim 12, wherein the second electrode section comprise an opening, and the first electrode sheet and the separator extend outside the second electrode section through the opening.

14. A method of manufacturing a lithium-ion coin battery having a winding core as an anode lead and a cathode lead, comprising:
providing a winding core, wherein the winding core comprises a first electrode section, a second electrode section and an insulating section isolating the first electrode section and the second electrode section;
welding a first electrode sheet, a second electrode sheet and a separator respectively on the first electrode section, the second electrode section and the insulating section, wherein the separator is isolated between the first electrode sheet and the second electrode sheet, and the a first electrode sheet, the second electrode sheet and the separator constitutes an electrode winding;
winding the electrode winding around the winding core;
placing the electrode winding and the winding core in a metal casing;
sealing a metal cover on the metal casing so that the metal cover and the metal casing are enclosed the electrode winding and the winding core; and
welding the first electrode section and the second electrode section respectively with the metal cover and the metal casing.

15. The method of manufacturing the lithium-ion coin battery having the winding core as the anode lead and the cathode lead of claim 14, wherein the metal casing further comprises a bottom and a sidewall, the bottom is opposite to the metal cover and welded directly with the second electrode section of the winding core, and the metal cover is welded directly with the first electrode section, and the electrode winding is placed in the metal casing, so that the sidewall of the metal casing surrounds the electrode winding.

16. The method of manufacturing the lithium-ion coin battery having the winding core as the anode lead and the cathode lead of claim 14, further comprising:
placing an insulating cover on an outer side of the metal cover; and
clamping an edge-locking rim of the metal casing on the insulating cover so that the metal cover and the insulating cover are fixed on the electrode winding.

17. The method of manufacturing the lithium-ion coin battery having the winding core as the anode lead and the cathode lead of claim 14, wherein the winding core is a rod-shaped structure extending in an axial direction of the lithium-ion coin battery, and the first electrode section and the second electrode section are respectively two ends of the rod-shaped structure with the insulating section in the a middle portion of the rod-shaped structure.

18. The method of manufacturing the lithium-ion coin battery having the winding core as the anode lead and the cathode lead of claim 17, wherein the first electrode sheet is welded on the first electrode section at a sidewall of the rod-shaped structure, the second electrode sheet is welded on the second electrode section at the sidewall of the rod-shaped structure, and the separator is welded on the insulating section at the sidewall of the rod-shaped structure.

19. The method of manufacturing the lithium-ion coin battery having the winding core as the anode lead and the cathode lead of claim 18, wherein a width of a portion of the first electrode sheet welded on the first electrode section in the axial direction is smaller than a length of the first electrode section in the axial direction, and a width of a portion of the second electrode sheet welded on the second electrode section in the axial direction is smaller than a length of the second electrode section in the axial direction, so that the first electrode sheet, the second electrode sheet and the separator are welded on the winding core in one welding action.
